(19) United States
(12) Patent Application Publication
(10) Pub. No.: US 2002/0090322 A1
(43) Pub. Date: Jul. 11, 2002

(54) Incubator

(75) Inventors: Fumio Sugaya, Kanagawa-ken (JP); Akihiro Komatsu, Kanagawa-ken (JP); Kazuhisa Kobayashi, Kanagawa-ken (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 10/042,320

(22) Filed: Jan. 11, 2002

(30) Foreign Application Priority Data
Jan. 11, 2001 (JP) 003178/2001

(51) Int. Cl. G01N 35/00

(52) U.S. Cl. 422/64; 422/63; 422/99

(57) ABSTRACT

An incubator has a dry analysis element chamber in which a dry analysis element is accommodated and held a constant elevated temperature. A pressing member is disposed in the upper portion of the dry analysis element chamber and presses downward a dry analysis element inserted into the dry analysis element chamber and a guide member supports the pressing member for up-and-down movement along a guide surface. A heater heats the guide member to a predetermined temperature. The pressing member is in contact with the guide surface of the guide member to receive heat from the guide surface and is moved up and down along the guide surface in response to insertion and removal of the dry analysis element into and from the dry analysis element chamber.

### BACKGROUND OF THE INVENTION

1. Field of the Invention

This invention relates to an incubator which is used in a biochemical analysis system, in which a sample such as blood or urine is spotted onto a dry analysis element by a spotting nozzle unit and the concentration, the ion activity and the like of a specific biochemical component contained in the sample are detected, to keep the dry analysis element at a constant temperature

2. Description of the Related Art

Recently, there has been put into practice a calorimetric dry (dry-to-the touch) analysis element with which the content of a specific biochemical component or a specific solid component contained in a sample liquid can be quantitatively analyzed by simply spotting a droplet of the sample liquid. Further, there has been put into practice an electrolytic dry analysis element with which the activity of a specific ion contained in a sample liquid can be determined by simply spotting a droplet of the sample liquid. Since being capable of analyzing samples easily and quickly, the biochemical analysis systems using such dry analysis elements are suitably used in medical institutions, laboratories and the like.

When quantitatively analyzing the chemical components or the like contained in a sample liquid using such a colorimetric dry analysis element, a droplet of the sample liquid is spotted on the analysis element, and the analysis element is held at a constant temperature for a predetermined time in an incubator so that a coloring reaction (pigment forming reaction) occurs, and the optical density of the color formed by the coloring reaction is optically measured. That is, measuring light containing a wavelength which is pre-selected according to the combination of the component to be analyzed and the reagent contained in the analysis element is projected onto the analysis element and the optical density of the analysis element is measured. Then the concentration of the component to be analyzed is determined on the basis of the optical density according to a calibration curve representing the relation between the concentration of the specific biochemical component and the optical density. In a potential difference measuring method using the electrolytic dry analysis element, the activity of a specific ion contained in a sample liquid spotted on an ion selective electrode pair of a dry analysis element is measured in a potentiometric way instead of measuring the optical density.

When such a dry analysis element is introduced into an incubator and is kept at an elevated constant temperature, it is necessary to air-tightly enclose the sample spotting portion of the dry analysis element in order to prevent evaporation of the sample during reaction. For this purpose, there has been generally employed an arrangement in which the spotting holes (through which the sample is spotted) of the dry analysis element is air-tightly enclosed by pressing against the dry analysis element a pressing member which is movable up and down in order to accept fluctuation in thickness of dry analysis elements. In this case, it is preferred that the pressing member can be lightly moved up and down in response to insertion of the dry analysis element so that sure operation of the pressing member can be ensured.

On the other hand, the dry analysis elements introduced into the incubator should be heated to a predetermined temperature and kept at the temperature. However, when the dry analysis elements are to be heated by heat supplied to the pressing member while the dry analysis elements are lightly pressed by the pressing member, there arises a problem that sufficient heat cannot be transferred to the pressing member through the spring which lightly presses the pressing member against the dry analysis elements.

In view of the problem, there has been employed a heating method in which as disclosed, for instance, in U.S. Pat. No. 4,298,571, the dry analysis elements and the part of the incubator in contact with the dry analysis elements are enclosed in a chamber kept at a constant temperature and the whole of the system including the dry analysis elements and the part of the incubator in contact with the dry analysis elements is heated, or as disclosed, for instance, in Japanese Unexamined Patent Publication No. 5(1993)-223829, the incubator is provided with an upper disc portion having a plurality of sliding holes which extend in the vertical direction and in which pressing members are held, and a heater is provided in the upper disc portion to heat the dry analysis elements by way of the pressing members which are heated by heat supplied thereto through the inner surface of the sliding holes.

However, the former method is disadvantageous in that since it is necessary to closely enclose the interior of the incubator, a mechanical shutter for closing a dry analysis element entry to the incubator is required, which complicates the structure of the incubator, and at the same time, since the dry analysis elements are heated by way of air, cold dry analysis elements cannot be heated immediately and accordingly, pre-heated dry analysis elements must be introduced into the incubator.

Further, the latter method is disadvantageous in that in order to increase the heat transfer efficiency, the space between the inner surface of the sliding hole and the pressing member should be small so that the air layer intervening between the inner surface of the sliding hole and the pressing member is thin, which requires a high working accuracy and adds to the manufacturing cost. Further when the upper disc portion is made thicker in order to enlarge the contact area between the pressing member and the sliding hole and to increase the amount of heat to be transferred to the pressing member from the sliding hole, the overall size of the incubator becomes large and the incubator becomes too heavy, which requires a heater of a larger capacity and a larger drive energy. This problem becomes more serious as the number of dry analysis elements to be accommodated in the incubator increases.

### SUMMARY OF THE INVENTION

In view of the foregoing observations and description, the primary object of the present invention is to provide an incubator which is simple in structure and light in weight.

In accordance with the present invention, there is provided an incubator having a dry analysis element chamber in which a dry analysis element is accommodated and held a constant elevated temperature, the incubator comprising

a pressing member which is disposed in the upper portion of the dry analysis element chamber and presses downward a dry analysis element inserted into the dry analysis element chamber, a guide member which supports the pressing member for up-and-down movement along a guide surface thereof, and a heater which heats the guide member to a predetermined temperature, wherein

the pressing member is in contact with the guide surface of the guide member to receive heat from the guide surface and is moved up and down along the guide surface in response to insertion and removal of the dry analysis element into and from the dry analysis element chamber.

It is preferred that the pressing member be urged downward by a spring.

Further, it is preferred that the pressing member is held in the dry analysis element chamber to be removable therefrom.

With the structure of the incubator described above, since heat is transferred to the pressing member through contact between the pressing member and the guide member instead of through an air layer, a large amount of heat can be transferred to the pressing member and accordingly, the dry analysis element can be introduced into the incubator without pre-heating. Further, since the dry analysis element is lightly moved up and down in response to insertion and removal of the dry analysis element into and from the dry analysis element chamber, the incubator can be light in weight and easy to produce, which reduces the manufacturing cost of the incubator.

When the pressing member is urged downward by a spring, the incubator can be lighter in weight as compared with when the pressing member presses the dry analysis element under its gravity. Further, when the pressing member is held in the dry analysis element chamber to be removable therefrom, cleaning and/or maintenance of the pressing member is facilitated without complicating the structure.

### BRIEF DESCRIPTION OF THE DRAWINGS

FIG. 1 is a perspective view showing a biochemical analysis system provided with an incubator in accordance with an embodiment of the present invention,

FIG. 2 is a plan view showing the incubator with the cover removed,

FIG. 3 is a cross-section view taken along line A-A in FIG. 2 with the dry analysis element in the dry analysis element chamber,

FIG. 4 is a view similar to FIG. 3 but with the dry analysis element discharged from the dry analysis element chamber, and

FIG. 5 is a fragmentary perspective view of the incubator.

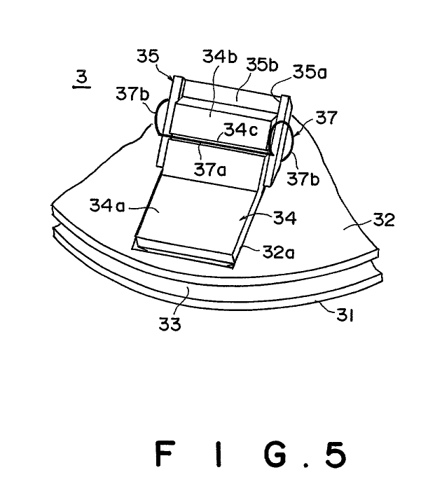

### DESCRIPTION OF THE PREFERRED EMBODIMENT

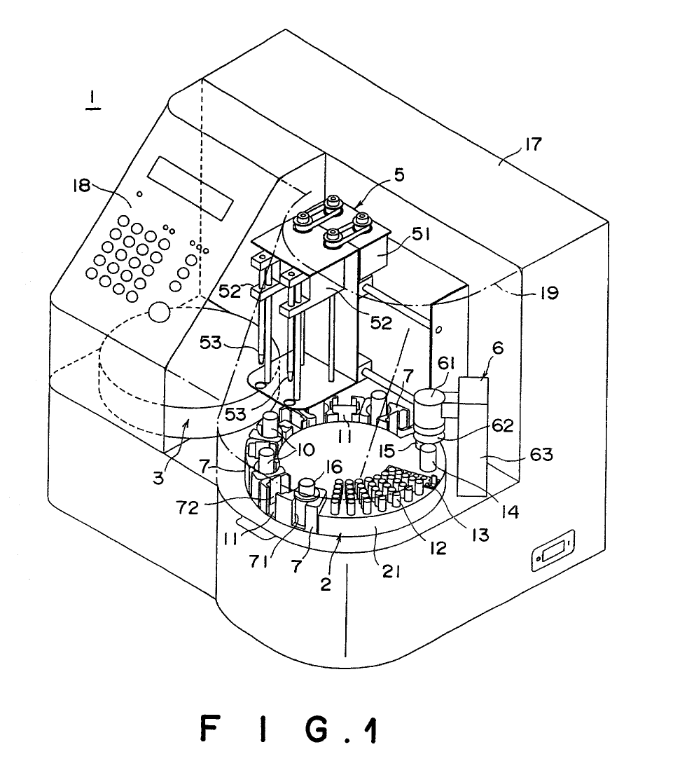

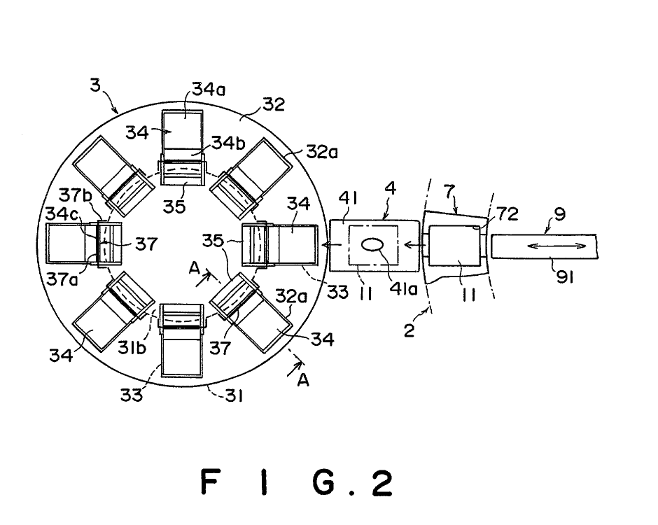

In FIG. 1, a biochemical analysis system 1 comprises a system body 17 and a circular sample tray 2 is provided on one side of the front portion of the system body 17. An incubator 3 is provided on the other side of the front portion of the system body 17, and a spotting station 4 (FIG. 2) is provided between the sample tray 2 and the incubator 3. Further a spotting nozzle unit 5 is provided on an upper portion of the system body 17 to be movable right and left. A dry analysis element 11 held in a sample cartridge 7 is moved to the spotting station 4 and spotted with a sample. Then the dry analysis element 11 spotted with the sample is transferred to the incubator 3. A blood filtering unit 6 for separating blood plasma from blood is provided beside the sample tray 2.

The incubator 3 comprises lower and upper disc members 31 and 32, and a plurality of (eight in this particular embodiment) element chambers 33 in which the dry analysis elements 11 are inserted are formed between the lower and upper disc members 31 and 32 arranged along the circumference of the disc members 31 and 32 at regular intervals. The bottom surface of each element chamber 33 is flush with the upper surface of the spotting station 4 and the dry analysis element 11 can be inserted into the chamber 33 from the spotting station 4 by simply pushing the element 11. The lower disc member 31 is supported by a support mechanism (not shown) to be rotatable in a horizontal plane, and is rotated in the regular direction and reverse direction by a drive mechanism (not shown).

Rectangular openings 32a are formed in the upper disc member 32 to be opposed to the element chambers 33. A pressing member 34 is disposed above each element chamber 33 to be opposed to the opening 32a. The pressing member 34 is provided with a flat pressing portion 34a and the lower surface of the pressing portion 34a presses downward the dry analysis element 11 inserted into the element chamber 33 to tightly close the spotting hole (to be described later) of the dry analysis element 11. The outer edge of the pressing portion 34a is tapered so that the dry analysis element 11 inserted into the element chamber 33 is brought into abutment against the tapered surface to push upward the dry analysis element 11. The pressing portion 34a may be smaller than the dry analysis element 11 in plan so long as it can be brought into close contact with the portion of the mount (to be described later) around the spotting hole to tightly close the spotting hole.

An inclined portion 34b extends obliquely upward from the inner edge of the pressing portion 34a of the pressing member 34 and is in sliding contact with a guide member 35 formed in the upper disc member 32. The guide member 35 extends obliquely upward from the inner edge of the opening 32a and a sliding channel 35a is formed on the upper surface of the guide member 35. The pressing member 34 is supported by the guide member 35 to be movable up and down along the inclined bottom (guide surface) 35b of the sliding channel 35a. The guide member 35 is heated to a predetermined temperature by a heater 36 provided on the upper disc member 32 near the guide member 35.

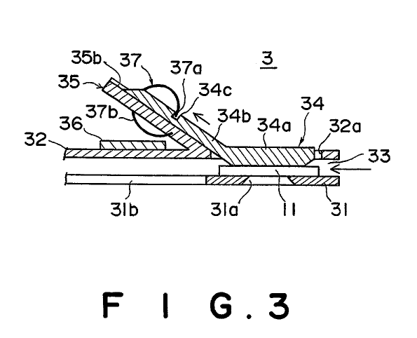

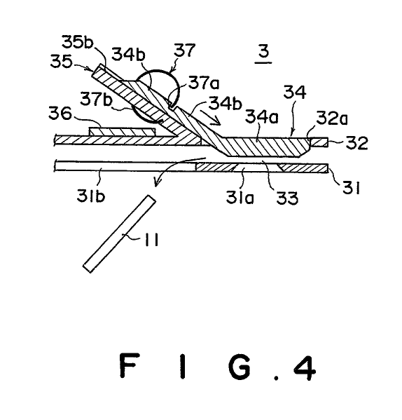

The pressing member 34 is lightly urged downward by a spring 37. The spring 37 comprises a linear engagement portion 37a and a curved spring portion 37b on each end of the engagement portion 37a. An engagement groove 34c extends across the inclined portion 34b, and the linear engagement portion 37a of the spring 37 is in engagement with the engagement groove 34c of the pressing member 34 with the free ends of the curved spring portions 37b of the spring 37 in engagement with the lower surface of the guide member 34. The pressing member 34 is lightly urged downward under the force of the spring 37. By disengaging the engagement portion 37a of the spring 37 from the engagement groove 34c of the pressing member 34, the pressing member 34 can be removed for cleaning and/or maintenance. The upper end portion of the inclined portion 34b of the pressing member 34 is tapered as clearly shown in FIGS. 3 and 4 so that the engagement portion 37a of the spring 37 is easily brought into engagement with the engagement groove 34c of the pressing member 34.

Downward movement of the pressing member 34 is stopped by abutment between the outer end face of the pressing portion 34a and the edge of the opening 32a as shown in FIG. 4. In this state, the space between the lower surface of the pressing portion 34a and the upper surface of the lower disc member 31 (the bottom surface of the element chamber 33) is smaller than the thickness of the dry analysis element 11.

A light measuring window 31a is formed in the bottom of the element chamber 33. Further, the lower disc member 31 is provided with a discarding hole 31b at the center thereof inside the element chambers 33, and after measurement, the dry analysis element 11 is dropped through the discarding hole 31b. (See FIG. 4)

Though not shown, the upper portion of the incubator 3 is covered with a cover and a discarding box for recovering the dry analysis elements is disposed below the discarding hole 31b.

With the structure of the pressing member 34, as a dry analysis element 11 is pushed into the element chamber 33 by an element transfer member 91 (to be described later), the pressing member 34 is moved upward along the inclined guide surface 35b of the guide member 35 as shown in FIG. 3. Thus, the dry analysis element 11 is pressed downward by the lower surface of the pressing portion 34a and at the same time is heated by heat which is supplied from the heater 36 to the incliner portion 34b in contact with the guide surface 35b of the guide member 35 and transferred to the pressing portion 34a from the inclined portion 34b. By controlling the heater 36, the dry analysis element 11 can be kept at a desired temperature. After measurement, the dry analysis element 11 is pushed out from the element chamber 33 by the element transfer member 91 and is dropped into the discarding hole 31b.

When the pressing member 34 is to be cleaned or maintained, the pressing member 34 can be removed from the incubator 3 by disengaging the engagement portion 37a of the spring 37 from the engagement groove 34c of the pressing member 34.

The guide member 35 and the heater 36 may be provided one for each element chamber 33 as shown in FIG. 2, or a plurality of guide members 35 and heaters 36 may be integrated so that a circular guide member is provided for the element chambers 33 and a circular heater is provided for the element chambers 33.

The incubator 3 is further provided with a measuring means (not shown). Since both a calorimetric dry analysis element and an electrolytic dry analysis element can be transferred to the incubator 3, the measuring means can carried out both the calorimetric measurement and the potential difference measurement. It is possible to provide first and second incubators so that one of the incubators is provided with a measuring means for carrying out the calorimetric measurement and the other incubator is provided with a measuring means for carrying out the potential difference measurement.

When the calorimetric measurement is to be carried out, the reflective optical density of the dry analysis element 11 is measured through the light measuring window 31a by a light measuring head (not shown). The lower disc member 31 of the incubator 3 is rotated to bring the element chambers 33 to a measuring position in sequence and the optical density due to the coloring reaction is measured for each element 11. Thereafter the lower disc member 31 is reversed to return the element chambers 33 to the initial position.

When the ion activity is to be measured, three pairs of holes are formed in the side wall of each element chamber 33 so that three pairs of probes for measuring the potential difference can be brought into contact with the ion selective electrodes of the electrolytic dry analysis element 11. When the sample liquid is spotted in one of the spotting holes while reference liquid is spotted in the other spotting hole, a potential difference corresponding to the difference in ion activity between the sample and the reference liquid is produced between the ion selective electrode pair. By detecting the potential differences between the ion selective electrode pairs, the activities of the respective ions in the sample can be measured.

The sample tray 2 comprises a disc-like turntable 21 which is rotated in opposite directions. Five sample cartridges 7 are mounted on the turntable 21 in an arcuate line. The sample cartridges 7 are removable separately from each other. Each sample cartridge 7 comprises a sample holding portion 71 which holds a sample container 10 (a blood-collecting tube) holding therein a sample, and an analysis element holding portion 72 which holds a stack of virgin dry analysis elements 11 (calorimetric dry analysis elements or electrolytic dry analysis elements) of different types.

Consumables are held on the other part of the upper surface of the turntable 21 along the outer periphery. For example, a number of nozzle tips 21, a mixing cup 13 (a molded product provided with a plurality of cup-like recesses), a diluent container 14 and a reference liquid container 15 are held on the turntable 21 the outer periphery thereof.

The consumables may be set on the sample tray 2 in the form of cartridges like the sample cartridge 7.

The turntable 21 of the sample tray 2 is rotated in the regular direction or the reverse direction by a drive mechanism (not shown) to positions where the spotting nozzle unit 5 operates. By controlling the angular position of the turntable and the position of the spotting nozzle unit 5, predetermined operations required to spotting the sample on the analysis element such as mounting a nozzle tip 12, sucking a sample, diluent or the reference liquid, and mixing the sample and the diluent are carried out.

An element transfer means 9 (FIG. 2) which transfers the dry analysis element 11 is provided at the central portion of the sample tray 2. The element transfer means 9 comprises an element transfer member 91 (an insertion lever) which is slid back and forth in a radial direction of the sample tray 2 by a drive mechanism (not shown). The element transfer means 9 causes the element transfer member 91 to push a dry analysis element 11 out of a sample cartridge 7 into the spotting station 4, to push the element 11 spotted with the sample into the incubator 3, and to further push the element 11 toward the center of the incubator 3 after measurement to discard the element 11. The element transfer means 9 controls the drive mechanism for the turntable 21 to bring the sample cartridges 7 to the spotting station 4 in sequence.

As shown in FIG. 3, the sample cartridge 7 is a sector in plan (the top surface and the bottom surface are sectorial) obtained by dividing the sample tray 2 by straight lines passing through the center of the sample tray 2. That is, the inner and outer end faces 7a and 7b are arcuate and right and left side faces are oblique faces directed toward the center of the sample tray 2.

When plasma of the sample is to be filtered, a holder 16 with a filter is mounted on the sample container 10 set in the sample cartridge 7 as shown in FIG. 1.

The dry analysis element 11 to be set in the sample cartridge 7 will be described, hereinbelow. The calorimetric dry analysis element 11 for measuring coloring of the sample generally comprises a square mount and a reagent layer provided in the mount. A spotting hole is formed on the surface of the mount and the sample is spotted in the spotting hole. The electrolytic dry analysis element 11 for measuring the activity of a specific ion in the sample is provided with a pair of spotting holes and the sample liquid is spotted in one of the spotting holes while reference liquid whose ion activity has been known is spotted in the other spotting hole. Further, the electrolytic dry analysis element 11 for measuring the activity of a specific ion in the sample is provided with three ion selective electrode pairs which are electrically connected to probes for measuring the potential difference. The dry analysis element 11 is provided with bar codes (not shown) representing information on the item to be analyzed.

The spotting station 4 (FIG. 2) is for spotting a sample such as plasma, whole blood, serum, urine or the like on the dry analysis element 11. At the spotting station 4, in the case of a calorimetric dry analysis element 11, a sample is spotted on the element 11 by the spotting nozzle unit 5 and in the case of an electrolytic dry analysis element 11, a sample and reference liquid are spotted on the element 11 by the spotting nozzle unit 5.

At the spotting station 4, there are provided an element support table 41 on which the dry analysis element 11 is placed and a spotting opening 41a through which the sample and/or the reference liquid is spotted is formed in the lid of the element support table 41. Though not shown, a bar code reader for reading the bar code on the element 11 is provided on the upstream side of the spotting station 4. The bar code reader is for identifying the item of measurement and controlling the subsequent spotting and measurement, and for detecting the position of the element 11 (whether the element 11 is upside down or in a wrong direction).

The spotting nozzle unit 5 (FIG. 1) comprises a horizontal movement block 51 which is movable in a horizontal direction and a pair of vertical movement blocks 52 which are movable up and down on the horizontal movement block 51. A spotting nozzle 52 is fixed on each of the vertical movement block 52. The horizontal movement block 51 and the vertical movement blocks 52 are moved in the respective direction by drive means (not shown). The spotting nozzles 53 are integrally moved right and left and are moved up and down independently of each other. For example, one of the spotting nozzles 53 is for spotting the sample, and the other is for spotting the diluent or the reference liquid.

The spotting nozzle 53 is in the form of a rod provided with an air passage extending in the axial direction and a pipette-like nozzle tip 12 is fitted on the lower end portion thereof. The spotting nozzles 53 are connected to air tubes respectively connected to syringe pumps (not shown), and a suction force and a discharge force are selectively supplied to the spotting nozzles 53. After measurement, the used nozzle tips 12 are removed from the spotting nozzles 53 and discarded.

The blood filtering unit 6 is inserted into the sample container 10 held in the sample tray 2 and sucks plasma through the holder 16 with a glass fiber filter which is mounted on the upper end of the sample container 10, thereby separating plasma from the blood and holding the separated plasma in a cup formed on the top of the holder 16. The blood filtering unit 6 comprises a sucking mechanism 61 which supplies suction force, and a suction pad 62 which is connected to a suction pump (not shown) and attracts the holder 16 under a suction force is provided on the lower end of the sucking mechanism 61. The sucking mechanism 61 is mounted on a support post 63 to be moved up and down by a drive mechanism (not shown). When the plasma is separated from the blood, the sucking mechanism 61 is moved downward to be brought into a close contact with the holder 16. In this state, the suction pump is operated to suck the whole blood in the sample container 10, whereby the plasma separated from the blood is introduced into the cup formed on the top of the holder 16. Thereafter, the sucking mechanism 61 is returned to the initial position.

In FIG. 1, a control panel 18 is provided above the incubator 3. The sample tray 2 and the spotting nozzle unit 5 are covered with a transparent protective lid 19 which is openable.

Operation of the biochemical analysis system of this embodiment will be described, hereinbelow. A sample container 10 and one or more unsealed dry analysis elements 11 suitable for the item of measurement are set in a sample cartridge 7 outside the system body 17. Then the lid 19 is opened and the sample cartridge 7 is set in the sample tray 2. When a plurality of samples are to be measured, a plurality of suitable sample cartridges 7 are set in the sample tray 2. Further consumables such as the nozzle tips 12, the mixing cups 13, the diluent containers 14 and the reference liquid containers 15 are set in the sample tray 2.

Then analysis is started. In case of emergency, analysis is interrupted and the sample cartridge 7 to be analyzed urgently is set in a vacant space or in place of another sample cartridge.

Blood plasma is first separated from the whole blood in the sample container 10 by the blood filtering unit 6. Then the sample tray 2 is rotated to bring the sample cartridge 7 containing therein a sample to be analyzed to the spotting station 4. Then one of the dry analysis elements 11 in the sample cartridge 7 is transferred to the spotting station 4 by the element transfer member 91 of the transfer means 9. On the way to the spotting station 4, the bar code on the element 11 is read by the bar code reader and the item of analysis and the like are detected. When the item of analysis represented by the bar code is ion activity measurement, processing differs according to the instruction on dilution and the like.

When the item of analysis represented by the bar code is colorimetry, the sample tray 2 is rotated to bring a nozzle tip 12 below the spotting nozzle 53 and the nozzle tip 12 is mounted on the spotting nozzle 53. Then the sample container 10 is moved and the spotting nozzle 53 is moved downward to dip the nozzle tip 12 into the sample and to cause the nozzle tip 12 to suck the sample. Thereafter the spotting nozzle 53 is moved to the spotting station 4 and spots the sample onto the dry analysis element 11 at the spotting station 4.

Then the dry analysis element 11 spotted with the sample is inserted into an element chamber 33 of the incubator 3. In response to insertion of the dry analysis element 11 into the element chamber 33, the pressing member 34 is moved upward and then presses downward the dry analysis element 11, whereby evaporation of the sample is prevented and the dry analysis element 11 is rapidly heated to a predetermined temperature by heat transferred from the heater 36. After insertion of the dry analysis element 11 into the element chamber 33, the lower disc member 31 of the incubator 3 is rotated to bring the element chambers 33 to the measuring position in sequence where the dry analysis element in the chamber 33 is opposed to the light measuring head and the reflective optical density of the element 11 is measured by the light measuring head. After the measurement, the lower disc member 31 is rotated to return the chamber 33 to the spotting position and the dry analysis element 11 is pushed toward the center by the element transfer member 91 to be discarded. The result of the measurement is output and the used nozzle tip 12 is removed from the spotting nozzle 53. Then processing is ended.

When the sample is to be diluted, e.g., when the blood is too thick to carry out accurate measurement, the sample tray 2 is moved to bring the nozzle tip 12 holding the sample to a mixing cup 13. Then the spotting nozzle 53 discharges the sample held by the nozzle tip 12 into the mixing cup 13. Then the used nozzle tip 12 is removed from the spotting nozzle 53, and a new nozzle tip 12 is mounted on the spotting nozzle 53. The spotting nozzle 53 causes the nozzle tip 12 to suck the diluent from the diluent container 14 and to discharge the diluent into the mixing cup 13. Thereafter the spotting nozzle 53 dips the nozzle tip 12 into the mixing cup and causes the nozzle tip 12 to repeat suck and discharge, thereby stirring the mixture in the mixing cup 13. Then the spotting nozzle 53 causes the nozzle tip 12 to suck the diluted sample and moves the nozzle tip 12 to the spotting station 4. At the spotting station 4, the spotting nozzle 53 causes the nozzle tip 12 to spot the diluted sample onto the dry analysis element 11. Then the aforesaid, light measuring step, element discarding step and result outputting step follow.

When the item of analysis represented by the bar code is ion activity measurement, an electrolytic dry analysis element 11 is transferred to the spotting station 4 and the nozzle tips 12 mounted on the respective spotting nozzles 53 are caused to suck the sample in the sample container 10 and the reference liquid in the reference liquid container 15. Thereafter, the sample liquid is spotted in one of the spotting holes and the reference liquid is spotted in the other spotting hole.

The electrolytic dry analysis element 11 spotted with the sample and the reference liquid is inserted into one of the element chambers 33 of the incubator 3. Then ion activity is measured by a potential difference measuring means. After the measurement the dry analysis element 11 is discarded, the result of the measurement is output and the used nozzle tips 12 are removed from the respective spotting nozzles 53. Then processing is ended.

In the incubator 3 of this embodiment, the dry analysis element 11 is tightly enclosed by the pressing member 34 which is moved up and down in response to insertion of the dry analysis element into the element chamber 33 and the dry analysis element 11 is heated by heat transferred to the dry analysis element 11 from the heater 36 through the guide member 35 and the inclined portion 34b of the pressing member 34 in contact with the guide member 35. Accordingly, the sample is surely prevented from evaporating and the dry analysis element 11 can be rapidly heated. Further since the pressing member 34 is lightly urged by the spring 37, the pressing member 34 can be lightly moved up and down in response to insertion and removal of the dry analysis element 11, whereby the incubator 3 can be simple in structure and light in weight, and the capacity of the heater and the energy required to drive the incubator 3 may be small. Further since the pressing member 34 is easily mounted and removed, cleaning and/or maintenance of the pressing member 34 is facilitated.

Though being an inclined surface in the embodiment described above, the guide surface 35b of the guide member 35 need not be an inclined surface. For example, the guide surface 35b may be erected so long as heat of the heater 36 can be transferred to the pressing member 34 by way of contact between the guide surface 35b and the pressing member 34.

What is claimed is:

1. An incubator having a dry analysis element chamber in which a dry analysis element is accommodated and held a constant elevated temperature, the incubator comprising
a pressing member which is disposed in the upper portion of the dry analysis element chamber and presses downward a dry analysis element inserted into the dry analysis element chamber, a guide member which supports the pressing member for up-and-down movement along a guide surface thereof, and a heater which heats the guide member to a predetermined temperature, wherein
the pressing member is in contact with the guide surface of the guide member to receive heat from the guide surface and is moved up and down along the guide surface in response to insertion and removal of the dry analysis element into and from the dry analysis element chamber.

2. An incubator as defined in claim 1 in which the pressing member is urged downward by a spring.

3. An incubator as defined in claim 1 in which the pressing member is held in the dry analysis element chamber to be removable therefrom.
